(19) United States
(12) Patent Application Publication
(10) Pub. No.: US 2009/0037265 A1
(43) Pub. Date: Feb. 5, 2009

(54) METHOD AND SYSTEM FOR CREATING, EXECUTING, AND MONITORING COMPLEX PRODUCT OFFERINGS

(75) Inventor: Sanjay K. Moona, Saratoga, CA (US)

Correspondence Address: OSHA LIANG L.L.P./SUN, TWO HOUSTON CENTER, 909 FANNIN, SUITE 3500, HOUSTON, TX, 77010, US

(73) Assignee: Sun Microsystems, Inc., Santa Clara, CA (US)

(21) Appl. No.: 11/831,384

(22) Filed: Jul. 31, 2007

(51) Int. Cl. G06Q 30/00

(52) U.S. Cl. 705/14

(57) ABSTRACT

A computer readable medium comprising software instructions for purchasing units, wherein the software instructions, when executed by a processor, enable a system including the processor to receive a request for an initial trial unit from a user, receive a request to purchase the initial trial unit from the user, complete the purchase of the initial trial unit using a first financial incentive, wherein the purchase of the initial trial unit is completed within an initial unit conversion period, provide, to the user, a second financial incentive to purchase at least one conversion unit after the completion of the purchase of the first unit, receive a request to purchase the at least one conversion unit, and complete the purchase of the at least one conversion unit using the second financial incentive, wherein the purchase of the second conversion unit is completed within a total promotion period.

### BACKGROUND

Typically, large businesses offer trial periods to customers for new products and technologies, during which customers can try a particular product or technology (i.e., a trial unit) for a specified length of time. Customers typically request a trial unit and the trial unit is subsequently shipped to the customer site. The trial period starts when the customer orders the trial unit or when the customer receives the trial unit, depending on how the trial offer is set up.

At the end of the trial period, customers can either purchase the trial unit or return the trial unit without incurring any cost. Such trial offers typically have a high return rate. If a customer chooses to return a trial unit, the customer is asked to provide comments and/or reasons for the return. Often times, customers return the trial unit because configurations and/or settings of the trial unit do not match the needs of the customer.

Conventionally, to facilitate such “try before you buy” programs, the price associated with the trial unit is a fixed, static price. Thus, upon initiating the trial period, the price of the trial unit typically cannot be changed due to accounting issues. Typically, the incentive for “try before you buy” programs is ‘deferred billing’, which allows the customer to be billed at a later point in time, such that the customer does not have to pay the purchase price of the trial unit immediately upon acquiring the trial unit. Additionally, the trial units in such programs may be returned with minimal or no financial impact to the customer.

### SUMMARY

In general, in one aspect, the invention relates to a computer readable medium comprising software instructions for purchasing units, wherein the software instructions, when executed by a processor, enable a system comprising the processor to: receive a request for an initial trial unit from a user, receive a request to purchase the initial trial unit from the user, complete the purchase of the initial trial unit using a first financial incentive, wherein the purchase of the initial trial unit is completed within an initial unit conversion period, provide, to the user, a second financial incentive to purchase at least one conversion unit after the completion of the purchase of the first unit, receive a request to purchase the at least one conversion unit, and complete the purchase of the at least one conversion unit using the second financial incentive, wherein the purchase of the second conversion unit is completed within a total promotion period.

In general, in one aspect, the invention relates to a computer readable medium comprising software instructions for purchasing units, wherein the software instructions, when executed by a processor, enable a system comprising the processor to receive a request for a first product, wherein the request is received within a total promotion period, present a first financial incentive for the purchase of the first product, wherein the first financial incentive is valid for a first time period, receive a request for the purchase of the first product, wherein the request for the purchase of the first product is received within the total promotion period, present a second financial incentive for the purchase of a second product after completing the purchase of the first product, wherein the second financial incentive is valid for a second time period, and receive a request for the purchase of the second product at the second financial incentive and within the second time period, wherein the second financial incentive is offered when first product is purchased within the total promotion period.

In general, in one aspect, the invention relates to a system for purchasing products. The system includes an incentive tracker system configured to receive a request for an initial trial unit from a user, receive a request to purchase the initial trial unit from the user, complete the purchase of the initial trial unit using a first financial incentive, wherein the purchase of the initial trial unit is completed within an initial unit conversion period, provide, to the user, a second financial incentive to purchase at least one conversion unit after the completion of the purchase of the first unit, receive a request to purchase the at least one conversion unit, and complete the purchase of the at least one conversion unit using the second financial incentive, wherein the purchase of the second conversion unit is completed within a total promotion period.

Other aspects of the invention will be apparent from the following description and the appended claims.

### BRIEF DESCRIPTION OF DRAWINGS

FIGS. 1-2 show systems in accordance with one or more embodiments of the invention.

FIG. 3 shows a flowchart in accordance with one or more embodiments of the invention.

FIG. 4 shows an example in accordance with one or more embodiments of the invention.

FIG. 5 shows a computer system in accordance with one or more embodiments of the invention.

### DETAILED DESCRIPTION

Exemplary embodiments of the invention will now be described in detail with reference to the accompanying figures. Like items in the figures are denoted with like reference numerals for consistency.

In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

Embodiments of the invention relate to a method and system for creating, executing, and monitoring complex product offers. More specifically, embodiments of the invention relate to a method and system for the monitoring and purchasing of a trial unit and subsequent conversion units. Further, embodiments of the invention provide a method and system for offering financial incentives for the purchase of a trial unit and subsequent conversion units.

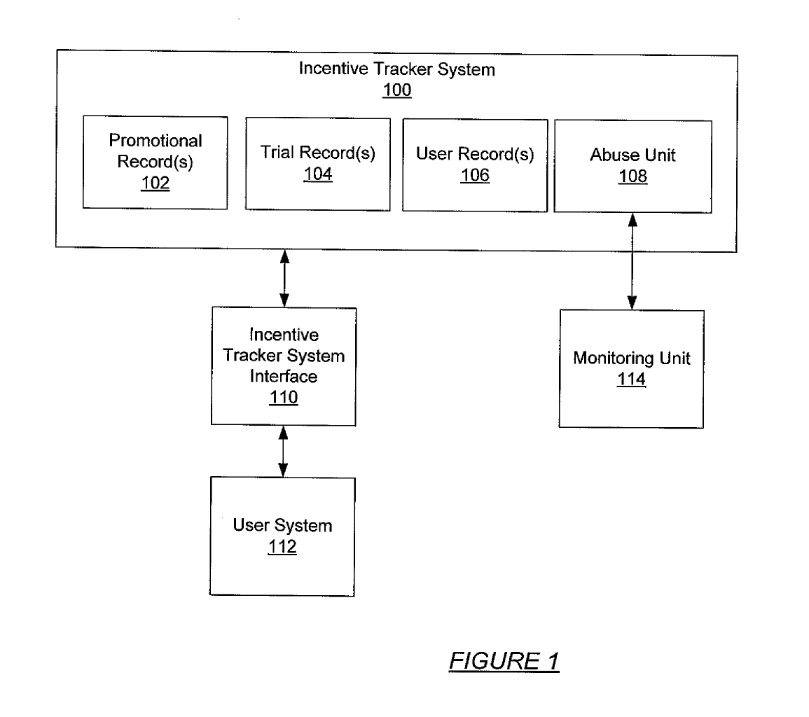

FIG. 1 shows a system for the purchase of a trial unit in accordance with one or more embodiments of the invention. In particular, the system of FIG. 1 includes an incentive tracker system (100), an incentive tracker system interface (110), a user system (112), and a monitoring unit (114). Further, the incentive tracker system (100) includes promotional record(s) (102), trial record(s) (104), user record(s) (106), and an abuse unit (108). Each of the aforementioned components shown in FIG. 1 is described in detail below.

In one or more embodiments of the invention, the incentive tracker system (100) is configured to offer promotions to users over a specific period of time, known as the total promotion period. More specifically, the total promotion period is the period of time during which a user may request a trial unit, purchase the trial unit, and purchase additional conversion units, while obtaining the benefit of promotions offered by the incentive tracker system (100). In one or more embodiments of the invention, the total promotion period is determined by the entity that offers the promotion(s) via the incentive tracker system (100). In one embodiment of the invention, a trial unit may be a product, a service contract (including, for example, technical support, maintenance contracts, software and/or hardware upgrades, etc.), select memberships and/or conditions, or any other type of goods/services offered by an entity, such as a company or enterprise. For example, a trial unit may be a product such as a server, a personal computer, a service contract, or any combination thereof. Further, a trial unit may be a membership subscription, such as a membership to a developer network that is subscribed to during a specific time. Conversion unit(s) may be additional units that are of the same type as the initial requested trial unit. For example, if a trial unit is a server, then conversion units may be additional servers purchased after the purchase of the initial trial server. Alternatively, in one or more embodiments of the invention, conversion unit(s) may be different products or services from the initial requested trial unit. For example, if a user requests a trial server, conversion units may be service contracts associated with the purchased server or different products offered by the entity. In one or more embodiments of the invention, when the trial unit is a membership subscription, electing to subscribe to the membership offered may provide subscribers with access to conversion units associated with a financial incentive.

In one or more embodiments of the invention, a promotion is a financial incentive offered for the purchase of a trial unit and additional conversion units. For example, a promotion may be a percentage discount on the purchase of a trial unit, a percentage discount on the purchase of one or more conversion units, an offer for free products or services associated with the purchase of a trial unit, or other types of financial incentives. Further, in order to offer financial incentives at the appropriate times within the total promotion period, the incentive tracker system (100) is configured to track the transactions associated with a request for a trial unit, the purchase of a trial unit, and the purchase of conversion units.

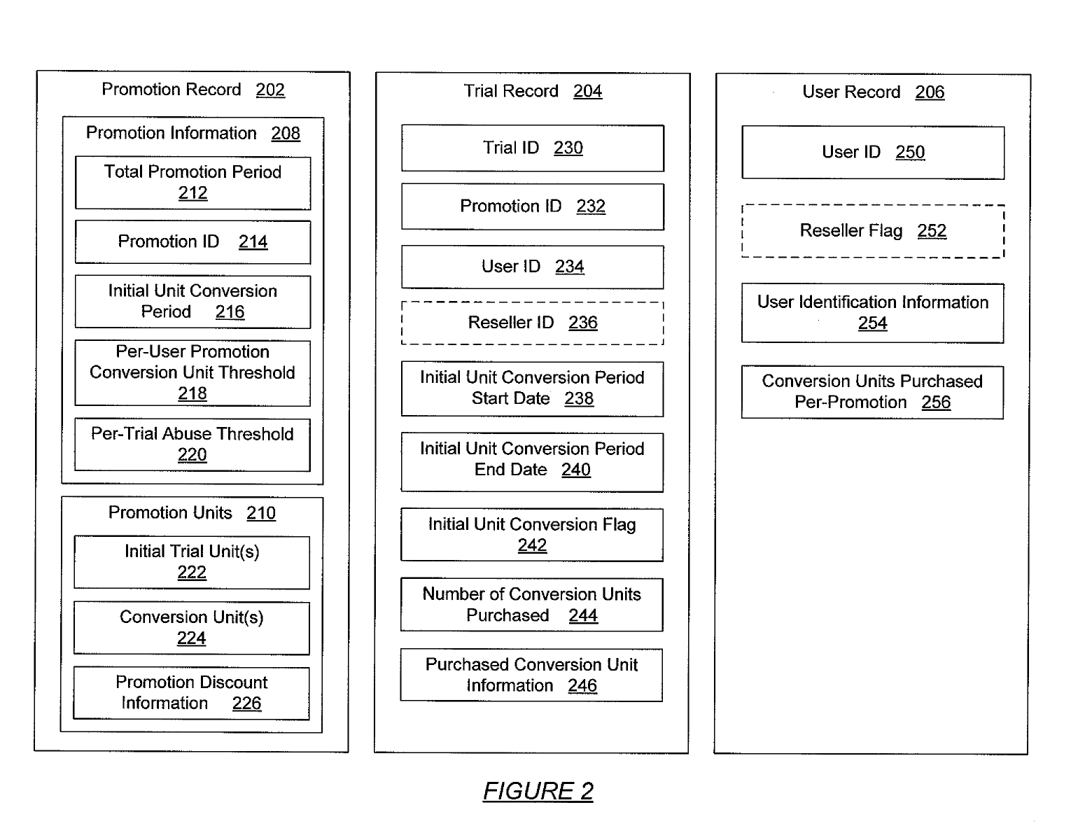

To facilitate the tracking of transactions associated with a request for and the purchase of a trial unit, the incentive tracker system uses promotional record(s) (102), trial record(s) (104), and user record(s) (106). In one embodiment of the invention, each type of record may be a file stored in the incentive tracker system. Briefly, a promotional record (102) stores information associated with each type of promotion being offered by the incentive tracker system (100). A trial record (104) stores information associated with each open trial. In one or more embodiments of the invention, a trial is opened when a user requests a trial unit. A user record (106) stores information associated with a particular user that initiates a trial. Each of the aforementioned types of records stored in the incentive tracker system (100) is described in further detail in FIG. 2.

In one embodiment of the invention, the abuse unit (108) within the incentive tracker system (100) is configured to detect abuse of the purchase of conversion units. In one embodiment of the invention, the abuse unit (108) may detect abuse by monitoring the information within the promotion record(s) (102), trial record(s) (104), the user record(s) (106), or any combination thereof. More specifically, the abuse unit (108) is responsible for detecting when the purchase of one or more conversion units exceeds one or more abuse thresholds set up by the incentive tracker system (100). The abuse unit (108) is operatively connected to a monitoring unit (114). The monitoring unit (114) is configured to receive an abuse alert from the abuse unit (108). In one embodiment of the invention, an abuse alert indicates the detection of abuse in the purchase of conversion unit(s). In one embodiment of the invention, the monitoring unit (114) is located external to the incentive tracker system. For example, the monitoring unit (114) may be an email address of a person associated with the entity offering promotions, which tracks and reports the alerts received from the abuse unit (108). Alternatively, the monitoring unit (114) may be a computer, a central database/server, or other device that automatically receives and reports abuse alerts from the abuse unit (108).

In one embodiment of the invention, the incentive tracker system interface is a front-end application that provides a user using the user system (112) with an interface to interact with the incentive tracker system (100). For example, in one or more embodiments of the invention, the incentive tracker system interface (100) may be a web application interface, a web site, a web service interface, etc. The user system (112) may be a web browser on a personal computer through which a user accesses the incentive tracker system interface (110). Alternatively, the user system (112) may be any electronic device through which a user accesses the incentive track system interface (110). For example, the user system (112) may be a mobile phone, a personal digital assistant, etc. Those skilled in the art will appreciate that a user using the user system (112) may be an individual a group of individuals, a company or enterprise, a reseller, or any other entity capable of initiating a trial with the incentive tracker system (100) via the incentive tracker system interface (110).

FIG. 2 shows a promotion record (202), a trial record (204), and a user record (206) in accordance with one or more embodiments of the invention. In one or more embodiments of the invention, each of the promotion record (202), the trial record (204), and the user record (206) is linked by the information included within each record. In one or more embodiments of the invention, a promotion record (202) includes information associated with a promotion being offered by the incentive tracker system. More specifically, the incentive tracker system stores a promotion record (202) for each promotion that is offered by an entity. Thus, each promotion record (202) is associated with one promotion. In one embodiment of the invention, the promotion record (202) includes promotion information (208) and identifies the promotion units (210) associated with that particular promotion.

In one embodiment of the invention, the promotion information (208) stored in each promotion record (202) includes the total promotion period (212), the promotion identification number (ID) (214), an initial unit conversion period (216), a per-user promotion conversion unit threshold (218), and a per-trial abuse threshold (220). The total promotion period (212), as noted above, is the total time period (i.e., a range of time) for which the promotion associated with the promotion record (202) is valid. In one or more embodiments of the invention, the start date and end date of a total promotion period (i.e., the time period within which the user may purchase the trial unit and purchase additional conversion units) is set by the entity running the promotion (e.g., the enterprise, company, etc., that is offering the promotions) independent of when a user initiates a trial by requesting a trial unit. For example, a particular promotion may be valid for 60 days, 90 days, 120 days, or any other range of time. In one or more embodiments of the invention, the total promotion period includes the initial unit conversion period and a time period to purchase additional conversion units (discussed below). The promotion ID (214) identifies the promotion with which the promotion record (202) is associated. In one embodiment of the invention, each promotion offered by the incentive tracker system is assigned a unique ID (e.g., an alphanumeric value, a binary value, or any other type of identification), which is used to identify the promotion.

In one or more embodiments of the invention, the initial unit conversion period (216) indicates the time period during which the initially requested trial unit may be purchased with the financial incentive for the purchase of the trial unit that is offered by the promotion. In one embodiment of the invention, the time left within the total promotion period (212) after the expiration of the initial unit conversion period (216) indicates the conversion unit(s) conversion period (not shown). The per-user promotion conversion unit threshold (218) indicates a maximum number of conversion units that may be purchased by a single user across all trials of the user, which are associated with the promotion. Finally, the per-trial abuse threshold (220) indicates the maximum number of conversion units that may be purchased with the financial incentives offered by the promotion on a per-trial basis (i.e., for each trial that the user initiates) before an abuse alert is triggered. For example, if the per-trial abuse threshold (220) is 10 units and the user purchases (or attempts to purchase) 11 units, an abuse alert is generated by the abuse unit.

The promotion units (210) within the promotion record (202) includes information associated with the initial trial unit(s) (222) and the conversion unit(s) (224). More specifically, the initial trial unit(s) (222) includes identification information for the initial trial units that are associated with the promotion. Because different trial units may be associated with different promotions, the initial trial unit(s) (222) identifies the one or more particular trial unit(s) to which the promotion identified by the promotion ID (214) applies. The identification information for the initial trial unit may be a universal product code (UPC) barcode number, a stock keeping unit (SKU) number, a radio frequency identification (RFID) tag, or any other unique graphical or alphanumeric identifier that identifies the initial trial unit. Similarly, the conversion unit(s) includes information identifying one or more conversion units that are associated with the promotion.

The promotion discount information (226) includes specifics about what financial incentives are offered by the promotion. In one or more embodiment of the invention, each promotion offers at least two distinct financial incentives. The first financial incentive is associated with the purchase of the initial trial unit. The second financial incentive is associated with the purchase of conversion units. In one or more embodiments of the invention, the first financial incentive may have a lesser monetary value (i.e., a lesser discount) than the second financial incentive. For example, the promotion discount information (226) may include the financial discount percentages for both the purchase of the initial trial unit and additional conversion units. Alternatively, in one embodiment of the invention, the promotion discount information (226) may include identifiers for free or discounted products, service contracts, etc., offered with the purchase of the trial unit(s) and/or the purchase of conversion unit(s) identified by the initial trial unit(s) (222) and the conversion unit(s) (224). In one or more embodiments of the invention, the second financial incentive may be a greater financial discount or an offer involving greater financial benefit to the user (i.e., the purchaser) than the first financial incentive.

Further, in one or more embodiment of the invention, the two financial incentives may be linked such that the second financial incentive is offered only if the initial trial unit is purchased within the initial unit conversion period. Alternatively, in one or more embodiments of the invention, the two financial incentives may be linked only by the act of purchasing the initial trial unit, regardless of when the initial trial unit is purchased. In this case, the second financial incentive for conversion units may be offered as long as the initial trial unit is purchased within the total promotion period. In this manner, the second financial incentive is used to motivate a user to convert the initial trial unit.

Continuing with FIG. 2, the trial record (204) includes a trial ID (230), a promotion ID (232), a user ID (234), an optional reseller ID (236), an initial unit conversion period start date (238), an initial unit conversion period end date (240), an initial unit conversion flag (242), a number of conversion units purchased (244), and purchased conversion unit(s) information (246). In one embodiment of the invention, each trial record (204) is associated with at most one promotion record (202) and at most one user record (206). Said another way, each trial is initiated by a single user associated with one user record (206) and is associated with a single promotion identified by a corresponding promotion record (202) that applies to that trial. In contrast, those skilled in the art will appreciate that the promotion record (202) and the user record (206) may be associated with multiple trial records.

The trial ID (230) identifies the trial initiated by the user. The trial ID may be any alphanumeric or binary identification. The promotion ID (232) links the trial record (204) to its corresponding promotion record and is the same ID that identifies the promotion in the promotion record. The user ID (234) identifies the user that initiated the trial. The user ID (234) may be any alphanumeric, binary, or other type of identifier that uniquely identifies the user. In one embodiment of the invention, a user may be a reseller. A reseller is a user that buys an initial trial unit and one or more conversion units for purposes of reselling the trial unit and the one or more conversion units. Said another way, a reseller does not buy trial units and/or conversion units for his/her own use. If a user is reseller, a reseller ID (236) that uniquely identifies the user as a reseller is also included in the trial record (204).

The initial unit conversion period start date (238) is the date starting on which the user may purchase the initial trial unit with the financial incentive offered by the promotion. Typically, the initial unit conversion period start date (238) corresponds to the date upon which the user requests the initial trial period. The initial unit conversion period end date (240) is the date on which the promotion associated with the purchase of the initial trial unit ends. That is, the user can no longer purchase the initial trial unit with the financial incentive offered by the promotion after the initial unit conversion period end date (240). The initial unit conversion period end date (240) is obtained by adding the initial unit conversion period (216) stored in the promotion record (202) to the initial unit conversion period start date (238) in the trial record (204). In the event that the initial unit conversion period end date (240) is after the end of the total promotion period (212), then the initial unit conversion period end date (240) is set to the date corresponding to the end of the total promotion period (212). The initial unit conversion flag (242) is a flag that indicates whether the initial trial unit was converted (i.e., purchased or a transaction, which is equivalent to a purchase occurs). The initial unit conversion flag (242) may be a Boolean value such as true/false or yes/no, or a binary value of 0 or 1.

Continuing with the description of the trial record (204), the number of conversion units purchased (244) indicates the number of additional units (i.e. in addition to the initial trial unit) the user purchased in the current trial. Using this value, the incentive tracker system may determine whether the per-trial abuse threshold (220) has been exceeded and/or whether the per-user promotion conversion unit threshold (218) has been reached. Finally, the purchased conversion unit information (246) stores the identifiers (e.g., SKU numbers, UPC numbers, RFID tags, etc.) correspond to the purchased conversion units.

In one or more embodiments of the invention, the user record (206) stores information associated with the user that initiates a trial. The user record (206) includes a user ID (250), a reseller flag (252), user identification information (254), and conversion units purchased per-promotion (256). The user ID (250) uniquely identifies the user. Thus, in one embodiment of the invention, the user record (206) is linked to a corresponding trial record (204) via the user ID (250) because each trial record (204) also includes the user ID (234). The reseller flag (252) may be a Boolean or binary value, which indicates whether the user is a reseller. Those skilled in the art will appreciate that if the reseller flag (252) in the user record (206) is false, then a reseller ID (236) may not be stored in the trial record (204). The user identification information (254) includes personal information about the user, such as the user's name, address, phone number, credit card information, etc. Finally, the conversion units purchased per-promotion (256) indicates the number of conversion units purchased by the user for each promotion offered by the system.

In one or more embodiments of the invention, the aforementioned incentive tracker system may be used by an enterprise, company, or other types of entities as a model to seed new technologies into the market in volume. More specifically, the incentive tracker system may be used in conjunction with trial offers that allow users to try products without any further obligations. By offering promotions to purchase a trial unit and to subsequently purchase conversion units, the present invention rewards users for trying new technologies quickly and make volume purchases of the new technologies. Offering promotions in this manner may reduce the return rate of the trial units (i.e., users may purchase the goods/services rather than return the goods/service upon completion of the trial period) and quickly captures larger footprints in customer installations.

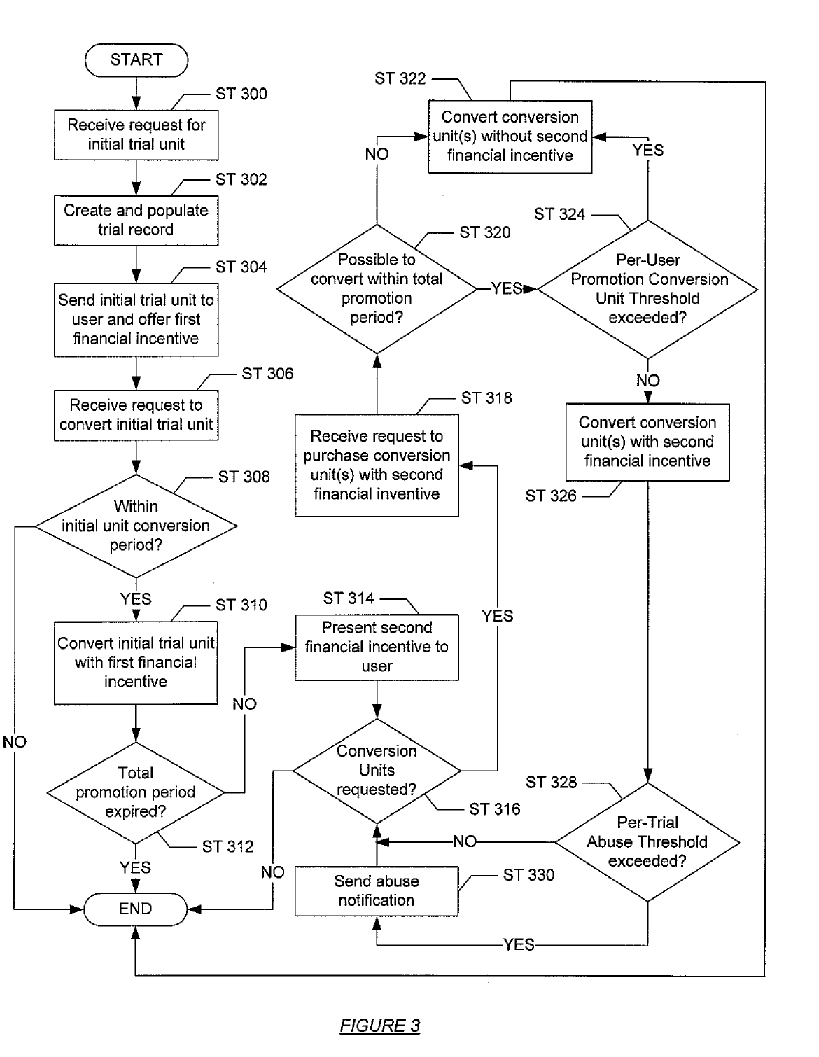

FIG. 3 shows a flow chart for purchasing an initial trial unit in accordance with one embodiment of the invention. Initially, a request for an initial trial unit is received (Step 300). As described above, requesting an initial trial unit may involve requesting a particular product, service contract, or other good/service on a trial basis. Further, the product, service contract, or other good/service may be requested with a particular configuration suited to the user's needs. Upon receiving a request for the initial trial unit, a trial record is created and populated with information known at the time the user request is received (Step 302). Those skilled in the art will appreciate that the trial record may be populated throughout the process described in FIG. 3, as additional information is gathered. In addition, although not shown in FIG. 3, the user record and promotion record may also be populated with known information at this stage in the process or with input directly from the user. Further, those skilled in the art will appreciate that a credit check and an export control check may be performed on a user application (i.e., an application used to request a trial unit initially) prior to entering data into the various records.

Next, the initial trial unit is sent and a first financial incentive is offered to the user (Step 304). Specifically, the initial trial unit is shipped to the user, and the user is presented with a first financial incentive to purchase the initial trial unit within the initial trial unit conversion period. In one or more embodiments of the invention, the first financial incentive is part of the promotion associated with the requested initial trial unit. In one or more embodiments of the invention, the first financial incentive may be a financial discount offered for the purchase of the initial trial unit, an offer for free products/services with the purchase of the initial trial unit, or any other type of financial incentive.

In one or more embodiments of the invention, the initial trial unit conversion period (i.e., the period of time during which the user is permitted to purchase the initial trial unit while obtaining the benefit of the first financial incentive) begins when the initial trial unit requested is actually received by the user. Those skilled in the art will appreciate that the initial trial unit conversion period may also begin when the initial trial unit is shipped to the user (i.e. before the purchase of the initial trial unit) or when the user initially requests the trial unit.

Subsequently, a request to convert (i.e., purchase) the initial trial unit is received (Step 306). Those skilled in the art will appreciate that the method of FIG. 3 assumes that the trial unit is converted by the user. However, those skilled in the art will appreciate that if the user chooses not to convert the trial unit and returns the trial unit after the expiration of the trial period, then the process ends. At this stage, a determination is made whether the request to convert the initial trial unit is received within the initial unit conversion period (Step 308). If the request is not received within the initial unit conversion period, then the process ends. Those skilled in the art will appreciate that the initial trial unit may still be purchased by the user after the initial unit conversion period, but the benefit of the first financial incentive would not apply to the purchase, and the trial is closed. Alternatively, in one or more embodiments of the invention, if the request to convert the initial trial unit is received within the initial unit conversion period, then the initial trial unit is converted with the first financial incentive offered by the promotion (Step 310). In one or more embodiments of the invention, converting the initial trial unit may involve receiving payment for the initial trial unit, issuing a purchase order for the initial trial unit, or any other equivalent action that indicates that the initial trial unit is purchased by the user.

Next, a determination is made whether the total promotion period has expired (Step 312). If the total promotion period has expired after the user converts the initial trial unit, then the process ends because no additional time to purchase conversion units remains. Alternatively, if the total promotion period has not expired, then a second financial incentive is presented to the user (Step 314). More specifically, in one or more embodiments of the invention, the first and second financial incentives are linked such that the second financial incentive for the purchase of conversion units may be presented only if the initial trial unit is converted within the initial unit conversion period. Said another way, the purchase of additional conversion units at a second financial incentive may be conditioned on the purchase of the initial trial unit within the initial unit conversion period within the total promotion period. Furthermore, in one or more embodiments of the invention, the initial unit conversion period must end before the remaining time period for the purchase of conversion units begins. Thus, in one embodiment of the invention, the two time periods included within the total promotion period (i.e., the initial unit conversion period and the remaining time period) are distinct and do not overlap. More specifically, the transaction associated with the purchase of the initial trial unit must be completed (i.e., the initial trial unit must be converted) before the second financial incentive for the purchase of conversion units is triggered.

After presenting the second financial incentive to the user, a determination is made whether conversion units are requested by the user (Step 316). If a request to purchase conversion units is not received and the total promotional period ends, then the process ends. However, if a request to purchase conversion units is received (Step 318), a determination is made whether it is possible to convert additional units within the total promotion period (Step 320). More specifically, because processing time may be involved to convert conversion units, if the request to convert conversion units is received too close to the end of the total promotion period, then the system may not be able to convert conversion units (i.e., complete payment of the addition units, issue a purchasing order for the conversion units, etc.) with the second financial incentive. In one or more embodiments of the invention, the processing time to convert conversion units may be dependent on the revenue or accounting system implemented by the enterprise or company associated with the promotion. If the system determines that it is not possible to convert the conversion units within the total promotion period, then the conversion units may be converted without the second financial incentive (Step 322). Alternatively, the user may not wish to complete the conversion of the conversion units upon learning that the second financial incentive will not apply, in which case the process may end (not shown).

Those skilled in the art will appreciate that embodiments of the invention assume that if the request to convert the initial trial unit is received at any point in time within the initial unit conversion period, then conversion of the initial trial unit is possible. Because the request to convert the initial trial unit applies only to a single unit, while a request to convert conversion units may involve multiple conversion units that the user may wish to purchase at the second financial incentive, it may be more difficult to process the conversion of conversion units than to convert the initial trial unit.

Continuing with FIG. 3, in contrast, if it is possible to convert the requested additional conversion units within the total promotion period (Step 320), then another determination is made as to whether the per-user promotion conversion unit threshold is exceeded (Step 324). If the user has requested the purchase of more than the threshold number of conversion units allotted to the user, then the method returns to Step 222, where the user has the option to purchase the excess conversion units without the second financial incentive. Though not shown in FIG. 3, the conversion units below the threshold level are processed in accordance with Step 326.

Continuing with the discussion of FIG. 3, if the per-user promotion conversion unit threshold is not exceeded, then the conversion unit(s) are converted with the second financial incentive (Step 326). Again, converting the conversion units may involve issuing a purchase order for the conversion units, receiving payment for the conversion units, etc. In addition, the conversion units are shipped to the user (not shown). At this stage, a determination is made whether the per-trial abuse threshold has been exceeded (Step 328). If the per-trial abuse threshold has been exceeded (i.e., the user purchased more conversion units than the threshold number for that particular trial), then an abuse notification is sent (Step 330). In one or more embodiments of the invention, even though an abuse threshold may be exceeded, the purchase of the conversion units with the second financial incentive is still permitted. Further, in one or more embodiments of the invention, the abuse notification triggers an investigation into whether the user is a reseller, the reasons why the user is purchasing a large number of conversion units, etc.

With respect to Step 314 of FIG. 3, those skilled in the art will appreciate that the second financial incentive may be offered even when the initial trial unit is not purchased within the initial unit conversion period. Rather, in one or more embodiments of the invention, the second financial incentive may be presented to the user as long as the initial trial unit is purchased sometime within the total promotion period. However, the purchase of an initial trial unit outside of the initial unit conversion period will not include a financial incentive for the initial trial unit (i.e., the initial unit will be available at regular price). Those skilled in the art will appreciate that a user may purchase conversion units at a different time period (i.e., outside of the initial unit conversion period), but still within the total promotion period. Thus, Steps 316-330 may be repeated, if the user wishes to purchase additional conversion units within the total promotion period. In addition, in one or more embodiments of the invention, each individual trial unit requested by the user triggers a separate and distinct transaction that operates in the same manner described above. Further, Those skilled in the art will appreciate that while the aforementioned method focuses on tracking of a request for an initial trial unit, the purchase of the initial trial unit, and the purchase of conversion units, the incentive tracker system may offer financial incentives for other types of events. For example, a promotion may offer financial incentives) after the purchase of more than one initial trial unit or after the purchase of a predetermined number of conversion units. Said another way, the invention is not limited, in any way, to the three events in the order in which they were described in the method above.

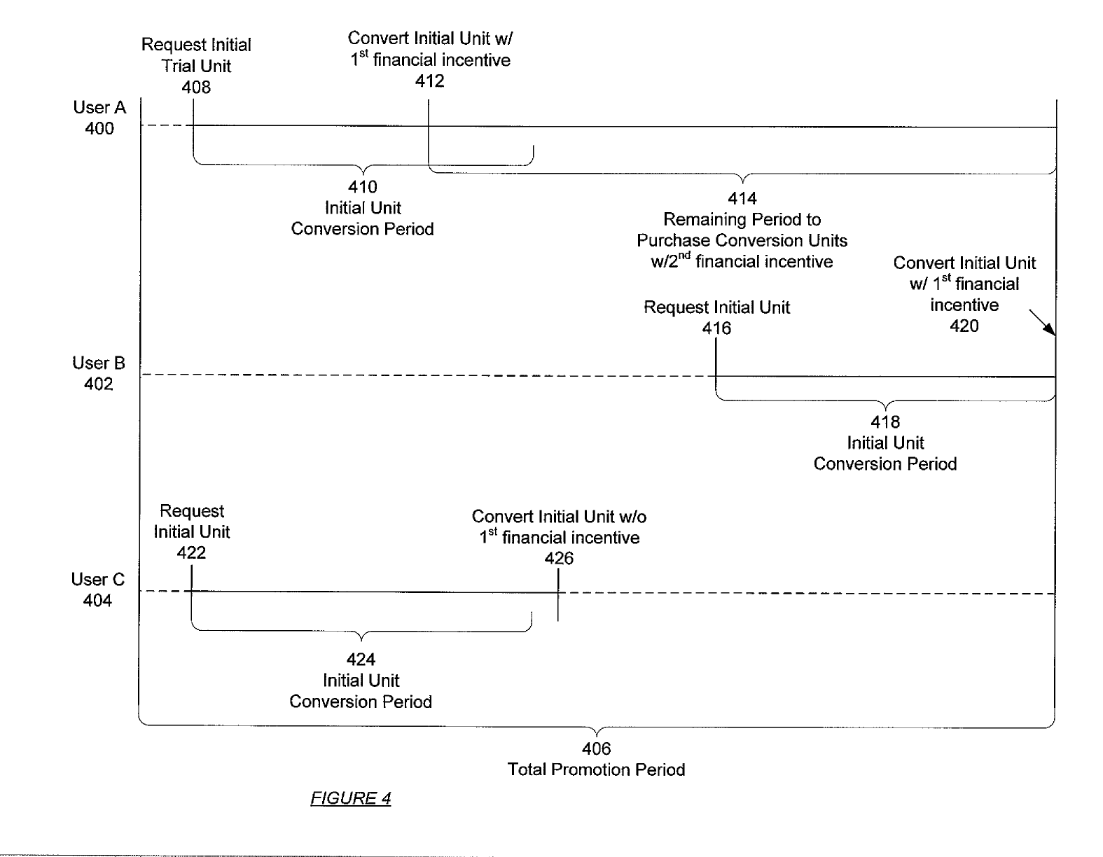

FIG. 4 shows examples of using embodiments of the present invention. Specifically, FIG. 4 shows three example scenarios for three different users, User A (400), User B (402), and User C (404). Each scenario takes place over a single total promotion period (406) and is described in detail below.

In the first scenario, assume User A (400) requests an initial trial unit (408) a few days into the total promotion period (406), triggering the start of the initial unit conversion period (410). At this time, User A (400) is presented with the first financial incentive, which applies if User A (400) decides to purchase the initial trial unit. For example, the first financial incentive may be a five percent discount on the purchase price of the initial trial unit. Alternatively, the first financial incentive may be a free service contract or another product that may be offered for free with the purchase of the initial trial unit at the full price, one free conversion unit with the purchase of the initial trial unit at the full price, a combination of a financial discount on the purchase price of the initial trial unit and one or more free products/services, etc. In one or more embodiments of the invention, the initial unit conversion period (410) applies only to the conversion of the single trial unit initially requested by the user.

Continuing with the first scenario, subsequently, the initial trial unit is converted within the initial unit conversion period with the first financial incentive (412). At this stage, User A (400) is presented with the second financial incentive associated with the purchase of conversion units. For example, the second financial incentive may be a fifteen percent discount on the purchase of each additional conversion unit. As shown in the first scenario, when the initial trial unit is converted (412), the initial unit conversion period ends (i.e., the initial unit conversion period is cut off) and the remaining period to purchase conversion units with the second financial incentive (414) begins. As described above, the second financial incentive associated with the purchase of conversion units is triggered by the close of the initial unit conversion period. In this scenario, User A (400) may purchase conversion units until the end of the total promotion period (or close to the end of the total promotion period, depending on the conversion processing time for conversion units).

For example, assume that the total promotion period is 120 days, and the initial conversion period is 30 days. In this case, if User A (400) converts the initial trial unit on day 15 (i.e., conversion is completed on day 15), then the remaining time period for purchasing of conversion units with the second financial incentive runs from day 16 to day 120. Thus, User A may purchase one or more conversion units on day 16, one or more conversion units on day 38, etc., until a few days before the end of the total promotion period.

Those skilled in the art will appreciate that if the user converts the initial trial unit within the initial unit conversion period but fails to convert additional conversion units within the total promotion period, then the additional conversion units may not be purchased with the second financial incentive.

In the second scenario shown in FIG. 4, User B (402) requests a trial unit (416) well into the total promotion period (406). Thus, the initial unit conversion period (418) starts almost toward the end of the total promotion period (406). In this scenario, the end of the initial unit conversion period (418) is also the end of the total promotion period (406). Because User B (402) converts the initial trial unit within the initial unit conversion period (418), User B (402) obtains the benefit of the first financial incentive (420). However, there is no time remaining for the purchase of conversion units because the initial trial unit is converted at the end of the total promotion period (418). Said another way, once the total promotion period expires, even if the initial trial unit is converted within the initial unit conversion period, the second financial incentive is not offered for the purchase of additional conversion units. To obtain the benefit of all the financial incentives offered by a single promotion, all transactions associated with the purchase of the initial trial unit and conversion units must be completed with the total promotion period.

For example, suppose in the second scenario that the total promotion period is 120 days and the initial unit conversion period is 30 days. If User B (402) requests a trial unit on day 90 of the total promotion period, then the end of the initial unit conversion period and the end of the total promotion period coincide. In such a scenario, if the user does not convert the initial trial unit with enough time remaining for the possibility of converting conversion units, then the user cannot purchase additional conversion units with at the second financial incentive associated with the promotion. However, as long as User B (402) requests conversion of the initial trial unit before the end of total promotion period, the initial trial unit may be converted at the first financial incentive offered by the promotion.

Finally, in the third scenario, User C (404) requests an initial trial unit (422) a few days into the total promotion period (406), triggering the start of the initial unit conversion period (424). At this time, User C (404) is presented with the first financial incentive for purchasing the initial trial unit (not shown). However, in this scenario, User C (404) does not convert the initial trial unit until after the expiration of the initial unit conversion period (426). In this case, the initial trial unit may be purchased by User C (404) without the first financial incentive. In addition, conversion units may be purchased by User C (404), but the second financial incentive may not be triggered because the initial trial unit was not converted within the initial unit conversion period (426). Thus, User C (404) may purchase the initially requested trial unit and additional conversion units as if no promotion is offered for any of the units. Alternatively, as described above, the act purchasing the initial trial unit, even though outside of the initial unit conversion period (426), may trigger the second financial incentive for the purchase of conversion units. In this scenario, even though a first financial incentive was not applied to the purchase of the initial trial unit, the user may purchase additional conversion units at the second financial incentive offered to the user. Those skilled in the art will appreciate that User C (404) may also initiate another trial by requesting a second initial trial unit, thereby initiating another trial, which provides financial incentives for both the purchase of the second initial trial unit and additional conversion units.

Those skilled in the art will appreciate that while the above description of the invention described purchasing an initial trial unit and purchasing a conversion unit(s), if the trial unit is something other than a product (e.g., a membership), then signing up/applying for the membership satisfies the “purchase” requirement of the initial trial unit and conversion unit(s). For example, if the initial trial unit is a membership, then conversion of the initial trial unit corresponds to applying for (and potentially being approved for the membership).

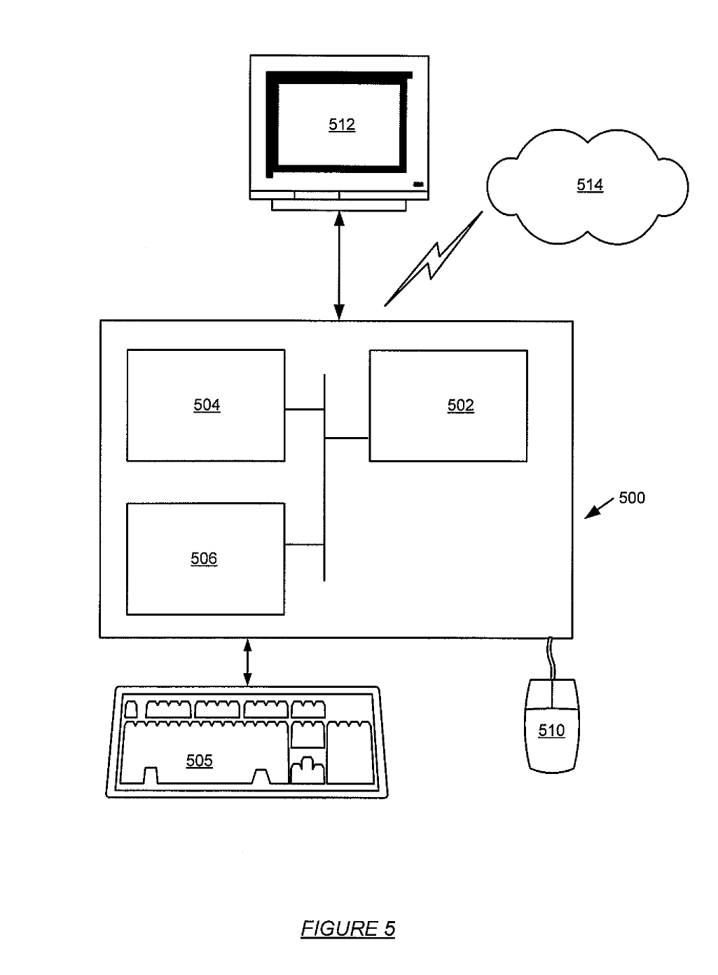

The invention may be implemented on virtually any type of computer regardless of the platform being used. For example, as shown in FIG. 5, a computer system (500) includes a processor (502), associated memory (504), a storage device (506), and numerous other elements and functionalities typical of today's computers (not shown). The computer (500) may also include input means, such as a keyboard (508) and a mouse (510), and output means, such as a monitor (512). The computer system (500) is connected to a local area network (LAN) or a wide area network (e.g., the Internet) (not shown) via a network interface connection (514). Those skilled in the art will appreciate that these input and output means may take other forms, now known or later developed.

Further, those skilled in the art will appreciate that one or more elements of the aforementioned computer system (500) may be located at a remote location and connected to the other elements over a network. Further, the invention may be implemented on a distributed system having a plurality of nodes, where each portion of the invention (e.g., the incentive tracker system, the incentive tracker system interface, the user system, etc.) may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

Embodiments of the invention provide a method and system for seeding new technologies into the marketplace by deploying new products into the marketplace quickly. The method and system provided by embodiments of the invention lowers the entry barrier for customers to try new technologies and rewards customers with financial incentives for desired behavior. This results in a reduction in the number of returns from trial offers. Further, because a purchased trial unit is tracked, and the transaction associated with the purchased trial unit is kept alive during the life of the financial incentive(s), revenue recognition systems can offer price discounts and other financial incentives while still adhering to generally accepted revenue recognition systems.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A computer readable medium comprising software instructions for purchasing units, wherein the software instructions, when executed by a processor, enable a system comprising the processor to:
receive a request for an initial trial unit from a user;
receive a request to purchase the initial trial unit from the user;
complete the purchase of the initial trial unit using a first financial incentive, wherein the purchase of the initial trial unit is completed within an initial unit conversion period;
provide, to the user, a second financial incentive to purchase at least one conversion unit after the completion of the purchase of the first unit;
receive a request to purchase the at least one conversion unit; and
complete the purchase of the at least one conversion unit using the second financial incentive, wherein the purchase of the second conversion unit is completed within a total promotion period.

2. The computer readable medium of claim 1, further comprising software instructions to:
send an abuse alert when a number of conversion units in the request to purchase the at least one conversion unit exceeds a per-trial abuse threshold.

3. The computer readable medium of claim 1, further comprising software instructions to:
create a trial record associated with the request for an initial trial unit.

4. The computer readable medium of claim 3, wherein the trial record comprises a trial identifier used to identify the trial record, a promotional identifier used to identify a promotion associated with the trial record, a user identification used to identify the user associated with the trial record, an initial unit conversion period start date, and an initial unit conversion period end date, wherein the difference between the initial unit conversion period start date and the initial unit conversion period end date is at most the initial unit conversion period.

5. The computer readable medium of claim 4, wherein the trial record further comprises a reseller flag indicating with the user is using a reseller to obtain the initial trial unit.

6. The computer readable medium of claim 1, wherein the initial trial unit comprises at least one selected from a group consisting of a device, a service contract, a membership subscription, and a condition associated with the membership subscription.

7. The computer readable medium of claim 1, wherein the first financial incentive and the second financial incentive are at least one selected from the group consisting of financial discounts on the purchase of the first product and the at least one additional product, and service contracts associated with the purchase of the first product and the at least one additional product.

8. The computer readable medium of claim 1, wherein the request to purchase the at least one conversion unit is denied when the number of conversion units in the request exceeds a per-user promotion conversion unit threshold.

9. A computer readable medium comprising software instructions for purchasing units, wherein the software instructions, when executed by a processor, enable a system comprising the processor to:
receive a request for a first product, wherein the request is received within a total promotion period;
present a first financial incentive for the purchase of the first product, wherein the first financial incentive is valid for a first time period;
receive a request for the purchase of the first product, wherein the request for the purchase of the first product is received within the total promotion period;
present a second financial incentive for the purchase of a second product after completing the purchase of the first product, wherein the second financial incentive is valid for a second time period; and
receive a request for the purchase of the second product at the second financial incentive and within the second time period,
wherein the second financial incentive is offered when first product is purchased within the total promotion period.

10. The computer readable medium of claim 9, wherein the first product is purchased without the first financial incentive.

11. The computer readable medium of claim 9, wherein the request for the purchase of the first product is received within the first time period, and wherein the first product is purchased at the first financial incentive.

12. The computer readable medium of claim 9, further comprising software instructions to:
create a trial record associated with the request for the first event.

13. The computer readable medium of claim 9, further comprising software instructions to:
receive a request for the purchase of a third product within the second time period, wherein the third product is purchased at the second financial incentive.

14. The computer readable medium of claim 13, wherein the first financial incentive and the second financial incentive are at least one selected from the group consisting of financial discounts on the purchase of the first product and the at least one additional product, and service contracts associated with the purchase of the first product and the at least one additional product.

15. The computer readable medium of claim 9, wherein the first financial incentive has a smaller monetary value than the second financial incentive.

16. The computer readable medium of claim 9, wherein the first time period ends at one selected from a group consisting of expiration of the first time period and completing of the purchase of the first product before the expiration of the first time period.

17. The computer readable medium of claim 9, wherein the first product and the second product are at least one selected from the group consisting of a device, a service contract, a membership subscription, and a condition associated with the membership subscription.

18. A system for purchasing products, comprising:
an incentive tracker system configured to:
receive a request for an initial trial unit from a user;
receive a request to purchase the initial trial unit from the user;
complete the purchase of the initial trial unit using a first financial incentive, wherein the purchase of the initial trial unit is completed within an initial unit conversion period;
provide, to the user, a second financial incentive to purchase at least one conversion unit after the completion of the purchase of the first unit;
receive a request to purchase the at least one conversion unit; and
complete the purchase of the at least one conversion unit using the second financial incentive, wherein the purchase of the second conversion unit is completed within a total promotion period.

19. The system of claim 18, further comprising:
an abuse detection unit configured to send an alert when a number of conversion units in the request to purchase the at least one conversion unit exceeds a per-trial abuse threshold.

20. The system of claim 18, wherein the incentive tracker system is further configured to:
create a trial record associated with the request for an initial trial unit, wherein the trial record comprises a trial identifier used to identify the trial record, a user identification used to identify the user associated with the trial record, an initial unit conversion period start date and an initial unit conversion period end date, wherein the difference between the initial unit conversion period start date and the initial unit conversion period end date is at most the initial unit conversion period.
